(19) United States
(12) Patent Application Publication
(10) Pub. No.: US 2019/0255649 A1
(43) Pub. Date: Aug. 22, 2019

(54) LASER BEAM MACHINING METHOD AND LASER BEAM MACHINE

(71) Applicant: Mitsubishi Electric Corporation, Tokyo (JP)

(72) Inventors: Yoshiharu KUROSAKI, Tokyo (JP); Tatsuya YAMAMOTO, Tokyo (JP); Kyohei ISHIKAWA, Tokyo (JP); Masayuki SAIKI, Tokyo (JP)

(73) Assignee: Mitsubishi Electric Corporation, Tokyo (JP)

(21) Appl. No.: 16/347,592

(22) PCT Filed: Sep. 26, 2017
(86) PCT No.: PCT/JP2017/034650

§ 371 Date: May 6, 2019

(51) Int. Cl. B23K 26/06; B23K 26/073; B23K 26/0622

(52) U.S. Cl. CPC B23K 26/0648; B23K 26/0622; B23K 26/073

(57) ABSTRACT

A laser machining beam method is a method that is carried out by a laser beam machine including a laser oscillator that is a first laser oscillator which emits a pulse of a laser beam that is a first laser beam, and a laser oscillator that is a second laser oscillator which emits a pulse of a laser beam that is a second laser beam differing in wavelength or pulse width from the first laser beam. In the laser beam machining method, the first laser beam and the second laser beam are caused to alternate in irradiating a workpiece.

### FIELD

The present invention relates to a laser beam machining method of machining a workpiece by means of laser beam irradiation and also relates to a laser beam machine.

### BACKGROUND

Machining of a workpiece by means of laser beam irradiation is expected to achieve such high machining quality as to minimize a thermally affected layer that remains in a workpiece.

A technique of a laser beam machine is disclosed in Patent Literature 1 and is such that a workpiece is machined by being irradiated with two laser beams having respective wavelengths in different ranges. The laser beam machine described in Patent Literature 1 irradiates the workpiece with the shorter-wavelength laser beam and the longer-wavelength laser beam with focal lengths being different from each other. Described in Patent Literature 1 are a first method of causing a focal point of the longer-wavelength laser beam to coincide with a spot center of the shorter-wavelength laser beam intended for preheating and a second method of forming a spot of the longer-wavelength laser beam that is intended to increase temperature of a molten workpiece with a focal point of the shorter-wavelength laser beam intended for machining being centered in the spot. A technique of a laser beam machine that is proposed in Patent Literature 2 is such that laser beams of different beam profiles irradiate a workpiece in a superposed manner.

### CITATION LIST

### Patent Literatures

Patent Literature 1: Japanese Patent Application Laid-open No. 2015-44238

Patent Literature 2: Japanese Patent Application Laid-open No. 2013-176800

### SUMMARY

### Technical Problem

There are cases where the techniques described in Patent Literatures 1 and 2 are attended with difficulty in obtaining high machining quality because a thermally affected layer increases depending on material used for the workpiece.

The present invention has been made in view of the above, and an object of the present invention is to obtain a laser beam machining method that enables high-quality machining.

### Solution to Problem

To solve the above-stated problem and to achieve the object, a laser beam machining method according to the present invention is a method that is carried out by a laser beam machine including a first laser oscillator that emits a pulse of a first laser beam, and a second laser oscillator that emits a pulse of a second laser beam differing in wavelength or pulse width from the first laser beam. In the laser beam machining method, the first laser beam and the second laser beam are caused to alternate in irradiating a workpiece.

### Advantageous Effect of Invention

The laser beam machining method according to the present invention enables high-quality machining.

### BRIEF DESCRIPTION OF DRAWINGS

FIG. 1 illustrates a configuration of a laser beam machine according to a first embodiment of the present invention.

FIG. 2 illustrates an example of an intensity distribution of a laser beam L1 on a workpiece illustrated in FIG. 1.

FIG. 3 illustrates an example of an intensity distribution of a laser beam L2 on the FIG. 1 workpiece.

FIG. 4 is a perspective view illustrating an example of a beam shaper illustrated in FIG. 1.

FIG. 5 is a top view of the FIG. 4 beam shaper.

FIG. 6 is a sectional view illustrating a thermally affected layer that results when the FIG. 1 workpiece is irradiated with a longer-wavelength laser beam.

FIG. 7 is a sectional view illustrating a thermally affected layer that results when the FIG. 1 workpiece is irradiated with a shorter-wavelength laser beam.

FIG. 8 is a first diagram illustrating how the laser beam machine illustrated in FIG. 1 carries out machining.

FIG. 9 is a sectional view of the workpiece, the section being taken along line IX-IX of FIG. 8.

FIG. 10 is a sectional view of the workpiece, the section being taken along line X-X of FIG. 8.

FIG. 11 is a second diagram illustrating how the laser beam machine illustrated in FIG. 1 carries out the machining.

FIG. 12 illustrates outputs of the laser beams L1 and L2 in the laser beam machine illustrated in FIG. 1.

FIG. 13 illustrates a modified example of the output of the laser beam L1 in the FIG. 1 laser beam machine.

FIG. 14 is a flowchart illustrating steps of a laser beam machining method according to the first embodiment.

FIG. 15 is a block diagram illustrating an example of a hardware configuration of a controller illustrated in FIG. 1.

FIG. 16 illustrates a configuration of a laser beam machine according to a second embodiment of the present invention.

FIG. 17 is a first diagram illustrating how the laser beam machine illustrated in FIG. 16 carries out machining.

FIG. 18 is a sectional view of the workpiece, the section being taken along line XVIII-XVIII of FIG. 17.

FIG. 19 is a sectional view of the workpiece, the section being taken along line XIX-XIX of FIG. 17.

FIG. 20 is a second diagram illustrating how the laser beam machine illustrated in FIG. 16 carries out the machining.

FIG. 21 illustrates outputs of laser beams L3 and L4 in the FIG. 16 laser beam machine.

FIG. 22 illustrates a modified example of the output of the laser beam L3 in the FIG. 1 laser beam machine.

FIG. 23 illustrates a modified example of the output of the laser beam L4 in the FIG. 1 laser beam machine.

### DESCRIPTION OF EMBODIMENTS

With reference to the drawings, a detailed description is hereinafter provided of laser beam machining methods and laser beam machine according to embodiments of the present invention. It is to be noted that these embodiments are not restrictive of the present invention.

### First Embodiment

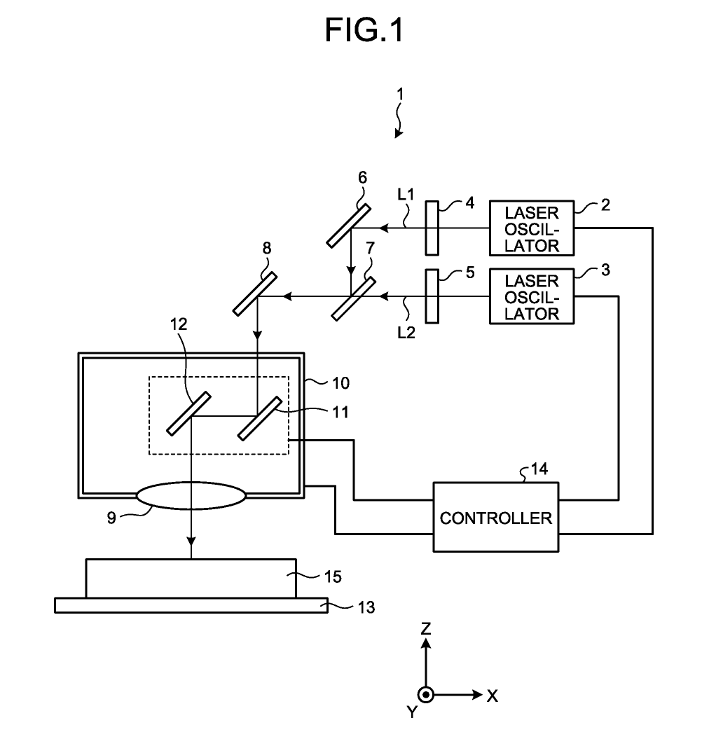

FIG. 1 illustrates a configuration of the laser beam machine 1 according to the first embodiment of the present invention. The laser beam machine 1 machines a workpiece 15 by means of laser beam irradiation. In FIG. 1, an X-axis and a Y-axis are two axes that are parallel to a horizontal direction and are perpendicular to each other.

A Z-axis is parallel to a vertical direction and is perpendicular to the X-axis and the Y-axis. A stage 13 has a plane that is parallel to the X-axis and the Y-axis, and the workpiece 15 is mounted on this plane. It is to be noted that an X-axis direction indicated by an arrow in the drawing is sometimes referred to as a positive X-direction, while an X-axis direction opposite to the direction indicated by the arrow is sometimes referred to as a negative X-direction. It is also to be noted that a Z-axis direction indicated by an arrow in the drawing is sometimes referred to as a positive Z-direction, while a Z-axis direction opposite to the direction indicated by the arrow is sometimes referred to as a negative Z-direction. The positive Z-direction is vertically upward. The negative Z-direction is vertically downward.

The laser beam machine 1 includes a laser oscillator 2 that is a first laser oscillator and a laser oscillator 3 that is a second laser oscillator. The laser oscillator 2 emits pulses of a first laser beam. The laser oscillator 3 emits pulses of a second laser beam that differs in wavelength from the first laser beam. A laser beam L1 is the first laser beam and is a pulsed laser beam having a first wavelength. A laser beam L2 is the second laser beam and is a pulsed laser beam having a second wavelength. The second wavelength is longer than the first wavelength. In the first embodiment, the laser beam L1 has the same pulse width as the laser beam L2 has.

A beam shaper 4 shapes the laser beam L1 that irradiates the workpiece 15 into a ring-shaped beam profile in which intensity is higher at a periphery than at a beam center. At the workpiece 15, the laser beam L1 thus has the ring-shaped beam profile in which the intensity is higher at the periphery than at the beam center. A beam shaper 5 shapes the laser beam L2 that irradiates the workpiece 15 into a circular beam profile in which intensity is maximal at a beam center. At the workpiece 15, the laser beam L2 thus has the circular beam profile in which the intensity is maximal at the beam center.

Each of the laser oscillators 2 and 3 is a solid-state laser, a semiconductor laser, a fiber laser, a CO₂ laser, or a CO laser. Examples of the first wavelength and the second wavelength include 10.6 μm, 9.3 μm, 5 μm, 1.06 μm, 1.03 μm, 532 nm, 355 nm, and 266 nm. The first wavelength and the second wavelength are set with the first wavelength being shorter than the second wavelength.

A mirror 6 is disposed in an optical path of the laser beam L1 that is emitted from the beam shaper 4. The mirror 6 reflects the laser beam L1 to cause the laser beam L1 to travel toward a dichroic mirror 7. The dichroic mirror 7 is disposed where the optical path of the laser beam L1 coming from the mirror 6 meets an optical path of the laser beam L2 coming from the beam shaper 5.

The dichroic mirror 7 has such a wavelength characteristic as to reflect light with the first wavelength and transmit light with the second wavelength. By reflecting the laser beam L1 and transmitting the laser beam L2, the dichroic mirror 7 causes the laser beams L1 and L2 to travel in the same direction. It is to be noted that the dichroic mirror 7 may reflect the laser beam L2 and transmit the laser beam L1.

A mirror 8 reflects the laser beams L1 and L2 coming from the dichroic mirror 7 to cause the laser beams L1 and L2 to travel toward a machining head 10. Galvano scanners 11 and 12 are housed in the machining head 10.

The galvano scanner 11 deflects, along the Y-axis, the laser beams L1 and L2 that irradiate the workpiece 15. The galvano scanner 11 shifts, along the Y-axis, respective incident positions of the laser beams L1 and L2 on the workpiece 15 by rotating its reflective surface that reflects the laser beams L1 and L2. The galvano scanner 12 deflects, along the X-axis, the laser beams L1 and L2 that irradiate the workpiece 15. The galvano scanner 12 shifts, along the X-axis, the respective incident positions of the laser beams L1 and L2 on the workpiece 15 by rotating its reflective surface that reflects the laser beams L1 and L2 coming from the galvano scanner 11. The galvano scanners 11 and 12 shift the laser beams L1 and L2 along the Y-axis and the X-axis.

A converging optical system 9 is provided at the machining head 10. The converging optical system 9 converges the laser beams L1 and L2. The converging optical system 9 includes one or a plurality of converging lenses. The converging optical system 9 may be an fθ lens that focuses the laser beams L1 and L2 to a position defined by fθ, namely, multiplication of a focal length f of the converging optical system 9 by a deflection angle θ of the galvano scanners 11 and 12. An entrance pupil of the converging optical system 9 is positioned in between the galvano scanners 11 and 12.

The laser beam machine 1 may include only one of the galvano scanners 11 and 12. The laser beam machine 1 may use a component other than the galvano scanners 11 and 12 to deflect the laser beams L1 and L2. The laser beam machine 1 may include, in place of the galvano scanners 11 and 12, an acousto-optic deflector (AOD) that uses an acousto-optic effect to deflect light, or an electro-optic deflector (EOD) that uses an electro-optic effect to deflect light.

The machining head 10 is movable along the X-axis and the Y-axis. The machining head 10 may be movable along only one of the X-axis and the Y-axis.

A controller 14 controls the entire laser beam machine 1. The controller 14 controls laser oscillation of each of the laser oscillators 2 and 3, driving of the machining head 10, and driving of each of the galvano scanners 11 and 12. By controlling the laser oscillators 2 and 3, the controller 14 causes one pulse of the laser beam L1 and one pulse of the laser beam L2 to alternate in irradiating the workpiece 15.

Examples of the workpiece 15 include composite materials such as a carbon fiber reinforced plastic (CFRP), a glass-fiber reinforced plastic (GFRP), and an aramid fiber-reinforced plastic (AFRP), a semiconductor thin film, and a glass material. In one example, the laser beam machine 1 cuts the workpiece 15 by means of irradiation with the laser beams L1 and L2.

The laser beam machine 1 irradiates a surface of the workpiece 15 that is positioned in the positive Z-direction with the laser beams L1 and L2. The laser beam machine 1 causes the laser beams L1 and L2 to irradiate the workpiece 15 along a common optical axis. “Along the common optical axis” means that the respective centers of the laser beams L1 and L2 that irradiate the workpiece 15 coincide. To cut the workpiece 15, the laser beam machine 1 scans the workpiece 15 with the laser beams L1 and L2 while alternating irradiation with the laser beam L1 and irradiation with the laser beam L2. The laser beam machine 1 may repeatedly scan the same line of the workpiece 15 with the laser beams L1 and L2 so that each position of that line is irradiated with the laser beams L1 and L2 multiple times. In that case, in order to cut the workpiece 15 along that line, the laser beam machine 1 repeats irradiation with the laser beams L1 and L2 until machining points reach a workpiece 15 surface positioned in the negative Z-direction.

It is to be noted that the laser beam machine 1 may carry out, in addition to cutting, grooving to make grooves or drilling to make holes. The workpiece 15 has only to be machined by being irradiated with the laser beams L1 and L2 multiple times and thus is not limited to the above-mentioned materials. The stage 13 may be movable in directions parallel to the X-axis and the Y-axis. The laser beam machine 1 shifts the respective incident positions of the laser beams L1 and L2 on the workpiece 15 by moving either one or both of the machining head 10 and the stage 13 and using scanning effected by the galvano scanners 11 and 12.

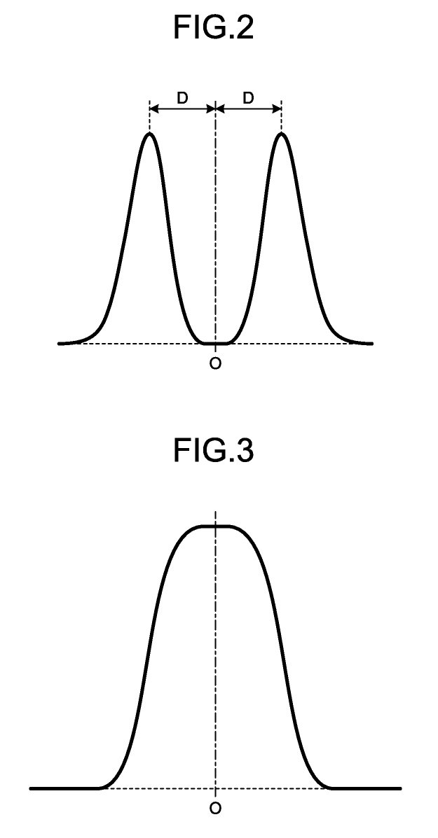

FIG. 2 illustrates an example of an intensity distribution of the laser beam L1 on the workpiece 15 illustrated in FIG. 1. A curve illustrated in FIG. 2 is a graph representing a relationship between distance from the center O of the laser beam L1 along each of the X-axis and the Y-axis and the intensity of the laser beam L1.

The intensity of the laser beam L1 is maximal at a certain distance D from the center O. The intensity of the laser beam L1 decreases heading from a position at the distance D toward the center O. The intensity of the laser beam L1 becomes zero at the center O. In an X-Y section of the laser beam L1 on the workpiece 15, a high-intensity portion appears in the shape of a ring along the periphery of the laser beam L1.

It is to be noted that the intensity at the center O of the laser beam L1 is not limited to zero. The intensity at the center O of the laser beam L1 has only to be less than a machining threshold of the workpiece 15. If the maximal intensity to be obtained is sufficient, the intensity at the center O of the laser beam L1 may be equal to or more than the machining threshold of the workpiece 15.

FIG. 3 illustrates an example of an intensity distribution of the laser beam L2 on the workpiece 15 illustrated in FIG. 1. The intensity distribution of the laser beam L2 is of flat-top shape with the intensity being maximal and constant within a certain distance from the center O of the laser beam L2. The laser beam L2 is a super-Gaussian beam having an intensity distribution that can be approximated as a super-Gaussian distribution. In an X-Y section of the laser beam L2 on the workpiece 15, a high-intensity portion appears in the shape of a circle in which the center O is centered.

It is to be noted that the laser beam L2 may be a Gaussian beam having an intensity distribution that can be approximated as a normal distribution. In that case, the intensity is maximal at the center O of the laser beam L2 and decreases with increasing distance from the center O. In an X-Y section of the laser beam L2 on the workpiece 15, a high-intensity portion appears in the shape of a circle in which the center O is centered.

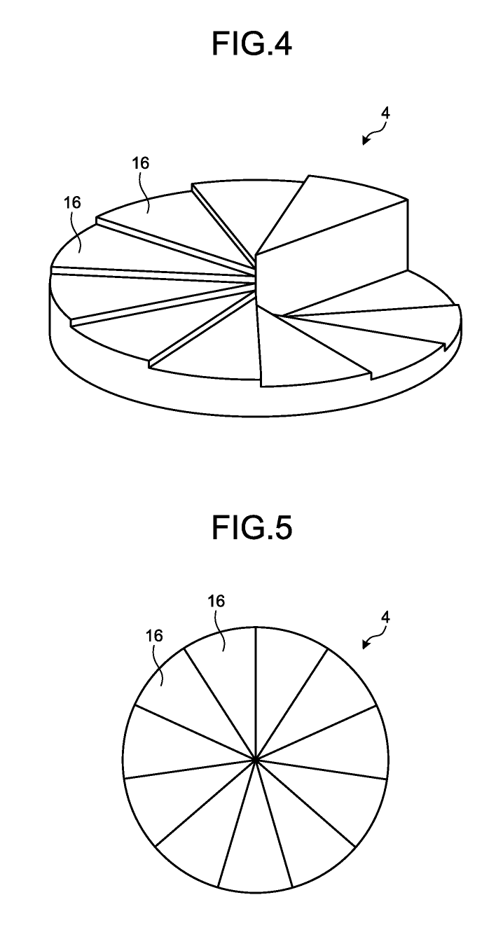

FIG. 4 is a perspective view illustrating an example of the beam shaper 4 illustrated in FIG. 1. FIG. 5 is a top view of the FIG. 4 beam shaper 4. The beam shaper 4 is an optical element including a plurality of transmissive areas 16 that have respective thicknesses varied in directions parallel to a principal ray of the laser beam coming from the laser oscillator 2. The transmissive areas 16 each form steps like a helix staircase. The beam shaper 4 causes a phase difference between light components each passing through the transmissive areas 16 having the different thicknesses, thus causing phase shifts to the laser beam coming from the laser oscillator 2. By causing such phase shifts, the beam shaper 4 converts the laser beam L1 coming from the laser oscillator 2 into the laser beam L1 having the ring-shaped intensity distribution.

The beam shaper 4 may be formed of a plurality of axicon lenses. The plurality of axicon lenses may be dispersed in the optical path of the laser beam coming from the laser oscillator 2. The beam shaper 4 may be the one that includes an aspheric lens that is not an axicon lens. It is to be noted that the laser beam machine 1 may include, in place of the laser oscillator 2 and the beam shaper 4, a laser oscillator that is capable of outputting a laser beam L1 having a higher-order, ring-shaped beam mode.

The beam shaper 5 illustrated in FIG. 1 is, for example, an aspheric lens. The laser beam machine 1 may include, in place of the laser oscillator 3 and the beam shaper 5, a laser oscillator that is capable outputting a laser beam L2 having a higher-order, circular beam mode.

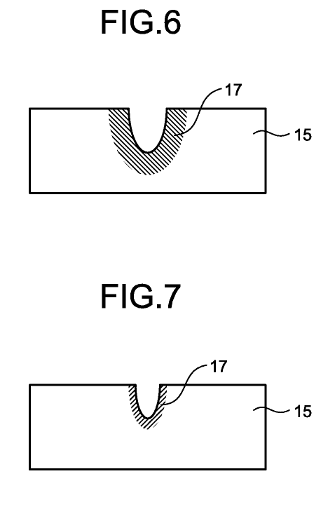

A description is provided here of difference between irradiation with a longer-wavelength laser beam and irradiation with a shorter-wavelength laser beam in the way the workpiece 15 is machined. FIG. 6 is a sectional view illustrating a thermally affected layer 17 that results when the workpiece 15 illustrated in FIG. 1 is irradiated with the longer-wavelength laser beam. FIG. 7 is a sectional view illustrating a thermally affected layer 17 that results when the workpiece 15 illustrated in FIG. 1 is irradiated with the shorter-wavelength laser beam.

The longer-wavelength laser beam is usually of high output power compared with the shorter-wavelength laser beam and thus can reach more deeply into the workpiece than the shorter-wavelength laser beam. If machining is carried out only with the longer-wavelength laser beam, the laser beam machine 1 can speed up the machining and thus is capable of high-speed machining. On the other hand, the machining using the longer-wavelength laser beam that reaches deep causes the thermally affected layer 17 to have an increased thickness.

The thermally affected layer 17 is a part of a laser-machined product that has been changed from its original state under thermal influence. If the material for the workpiece 15 is a fiber reinforced plastic; in the thermally affected layer 17, a plastic component is removed, but a fiber component remains. Such a thermally affected layer 17 causes decreased strength and deteriorated appearance of the machined product, so that the more the thermally affected layer 17 remains in extent in the machined product, the more degraded the quality of the machined product.

The shorter-wavelength laser beam is of low output power compared with the longer-wavelength laser beam, so that the thermally affected layer 17 that results from energy penetration can be made smaller. If machining is carried out only with the shorter-wavelength laser beam, the laser beam machine 1 can achieve high-quality machining. On the other hand, the shorter-wavelength laser beam requires a longer time for machining and may cause a significantly extended period of time from start to end of the machining of the workpiece 15. Laser machining of workpieces is expected to achieve both efficiency and high quality.

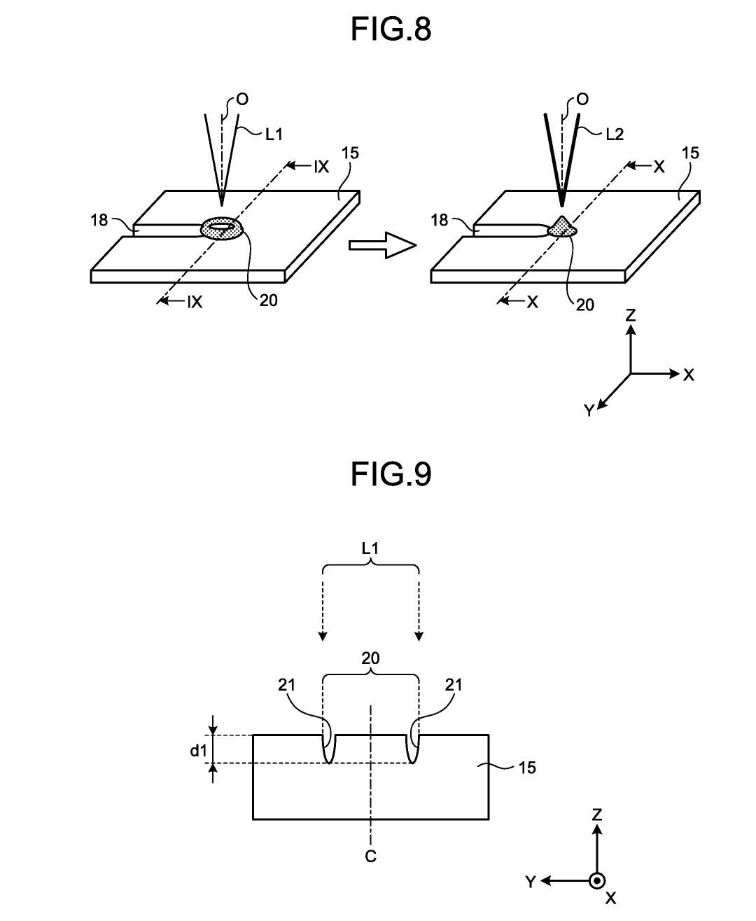

A description is provided next of a machining procedure based on the laser beam machining method according to the first embodiment. FIG. 8 is a first diagram illustrating how the laser beam machine 1 illustrated in FIG. 1 carries out machining. FIG. 8 illustrates how the workpiece 15 is irradiated with each of the laser beams L1 and L2 while cutting proceeds in the positive X-direction. The workpiece 15 is formed with a cut surface 18 at its machined part. The laser beam machine 1 causes the respective centers O of the laser beams L1 and L2 to coincide and directs the laser beams L1 and L2 toward a machining area 20 in turn. The laser beam machine 1 can direct the cutting in any direction along each of the X-axis and the Y-axis.

FIG. 9 is a sectional view of the workpiece 15, the section being taken along line IX-IX of FIG. 8. The laser beam machine 1 machines a ring-shaped outer peripheral portion of the machining area 20 by means of irradiation with the laser beam L1 with the center O of the laser beam L1 coinciding with a center position C of the machining area 20. A machined groove 21 having a depth d1 is thus formed in the outer peripheral portion of the machining area 20. The machined groove 21 is ring-shaped in an X-Y plane.

With the intensity at the center O of the laser beam L1 being zero or less than the machining threshold, the center position C of the machining area 20 and its proximity are not machined. It is to be noted that the intensity at the center O of the laser beam L1 may be equal to or more than the machining threshold of the workpiece 15, provided a machined groove 21 can be formed to have a deep shape relative to the surface of the workpiece 15 positioned at the center position C.

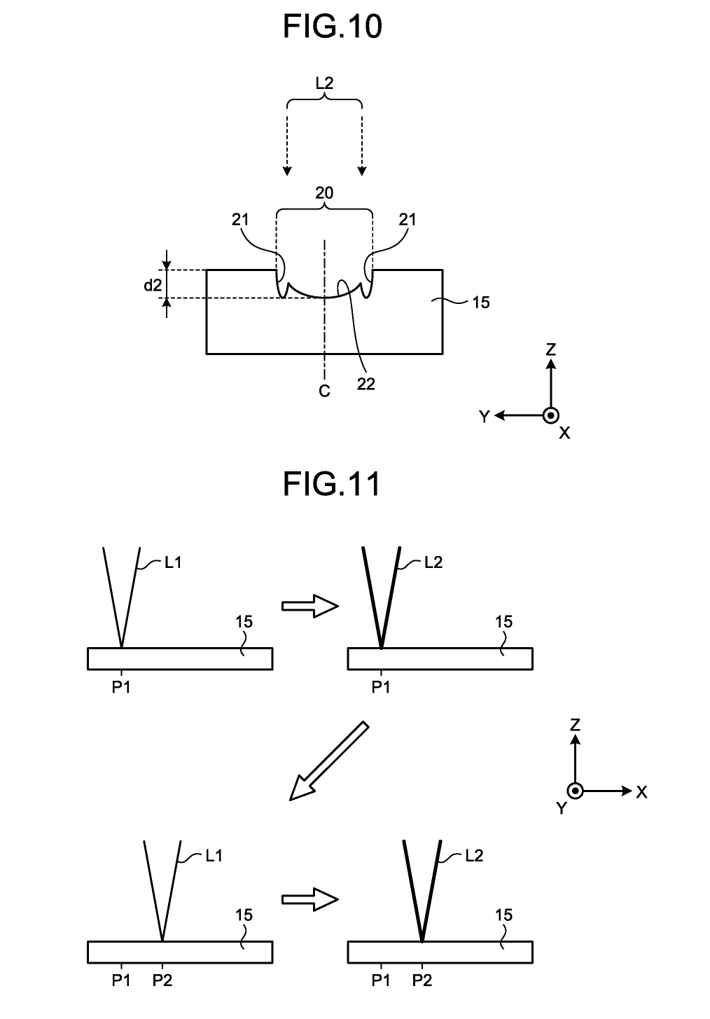

FIG. 10 is a sectional view of the workpiece 15, the section being taken along line X-X of FIG. 8. After irradiating with the laser beam L1, the laser beam machine 1 irradiates the machining area 20 with the laser beam L2, thus machining a circular portion surrounded by the outer peripheral portion of the machining area 20. Consequently, a machined groove 22 having a depth d2 is formed in the portion surrounded by the outer peripheral portion. The machined groove 22 formed is closer to the center position C than an outer edge of the machined groove 21 formed by the laser beam L1 is.

A portion extending outwardly from the machined groove 21 along the X-axis and the Y-axis of the workpiece 15 remains as a portion of a machined product. By forming the machined groove 21 by means of the irradiation with the shorter-wavelength laser beam L1, the laser beam machine 1 can lessen thermally affected layer 17 that remains in the machined product.

By forming the machined groove 21 before the irradiation with the laser beam L2, the laser beam machine 1 keeps the portion that is to be removed by the laser beam L2 apart from the portion that remains in the machined product. A thermally affected layer 17 that results from the irradiation with the longer-wavelength laser beam L2 is thus limited to an area that is closer along the X-axis and the Y-axis to the center position C than the outer edge of the machined groove 21 is. In this way, the laser beam machine 1 can suppress X-axis and Y-axis expansion of the thermally affected layer 17 from the machining area 20 and thus can lessen the thermally affected layer 17 that remains in the machined product.

By including the machining using the longer-wavelength laser beam L2, the laser beam machine 1 can achieve a reduced time required to machine compared to when carrying out machining using only the shorter-wavelength laser beam. As such, the laser beam machine 1 can efficiently machine the workpiece 15.

The depth d2 of the machined groove 22 formed by a single irradiation with the laser beam L2 is the same as the depth d1 of the machined groove 21 formed by a single irradiation with the laser beam L1. By using the machined groove 21 to block the expansion of the thermally affected layer 17 that results from the irradiation with the laser beam L2, the laser beam machine 1 can suppress the expansion of the thermally affected layer 17. It is to be noted that the depth d1 of the machined groove 21 formed by the single irradiation with the laser beam L1 is not limited to being the same as the depth d2 of the machined groove 22 formed by the single irradiation with the laser beam L2. The depth d1 of the machined groove 21 may be deeper than the depth d2 of the machined groove 22. Even in that case, the laser beam machine 1 can suppress expansion of the thermally affected layer 17 that results from irradiation with the laser beam L2.

FIG. 11 is a second diagram illustrating how the laser beam machine 1 illustrated in FIG. 1 carries out the machining. The laser beam machine 1 shifts, through driving of the machining head 10, respective irradiation positions of the laser beams L1 and L2 in the positive X-direction from a machined part.

After aiming the laser beams L1 and L2 at a position P1 illustrated in FIG. 11, the laser beam machine 1 carries out machining using irradiation with the laser beam L1 and thereafter carries out machining using irradiation with the laser beam L2. Upon finishing the machining of the position P1 by means of the laser beams L1 and L2, the laser beam machine 1 shifts respective aims of the laser beams L1 and L2 to a position P2 that is adjacent to the position P1 in the positive X-direction. The laser beam machine 1 carries out machining by irradiating the position P2 with the laser beam L1 followed by the laser beam L2. While shifting the respective aims of the laser beams L1 and L2 in this way, the laser beam machine 1 repeatedly alternates irradiation with one pulse of the laser beam L1 and irradiation with one pulse of the laser beam L2 to machine the workpiece 15. The laser beam machine 1 not only shifts the positions after the single irradiations with the respective laser beams L1 and L2 but may also shift the positions after irradiating multiple times with each of the laser beams L1 and L2.

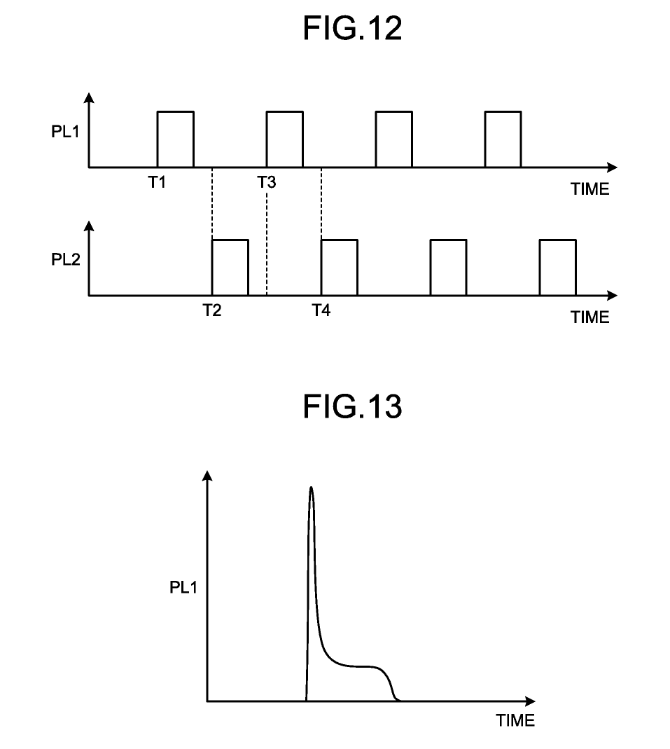

FIG. 12 illustrates outputs of the laser beams L1 and L2 in the laser beam machine 1 illustrated in FIG. 1. In FIG. 12, a vertical axis PL1 represents power of the laser beam L1, a vertical axis PL2 represents power of the laser beam L2, and horizontal axes represent time. The laser beam machine 1 repeatedly turns on and off output of the laser beam L1 with the power being constant. The laser beam machine 1 repeatedly turns on and off output of the laser beam L2 with the power being constant. The outputs of the laser beams L1 and L2 are each represented by a rectangular wave having a constant width.

At a time T1, the laser beam machine 1 emits the laser beam L1 toward the position P1. At a time T2 subsequent to the time T1, the laser beam machine 1 emits the laser beam L2 toward the position P1. By letting the controller 14 control the laser oscillators 2 and 3, the laser beam machine 1 directs the laser beam L1 toward a machining area 20 corresponding to the position P1 and then directs the laser beam L2 toward that machining area 20.

Next, the laser beam machine 1 emits the laser beam L1 toward the position P2 at a time T3 subsequent to the time T2. At a time T4 subsequent to the time T3, the laser beam machine 1 emits the laser beam L2 toward the position P2. By letting the controller 14 control the laser oscillators 2 and 3, the laser beam machine 1 directs the laser beam L1 toward a machining area 20 corresponding to the position P2 and then directs the laser beam L2 toward that machining area 20. With the controller 14 performing the control, the laser beam machine 1 irradiates the workpiece 15 alternately with the one pulse of the laser beam L1 and the one pulse of the laser beam L2. It is to be noted that the laser beam machine 1 may irradiate the workpiece 15 alternately with multiple pulses of the laser beam L1 and multiple pulses of the laser beam L2. The pulse of the laser beam L1 and the pulse of the laser beam L2 may overlap each other.

The laser beam machine 1 not only cuts the workpiece 15 by irradiating each of the positions of the workpiece 15 once with each of the laser beams L1 and L2 but may also cut the workpiece 15 by irradiating each of the positions of the workpiece 15 multiple times alternately with the laser beam L1 and the laser beam L2. In that case, the laser beam machine 1 may scan the workpiece 15 with the laser beams L1 and L2 multiple times through driving of the galvano scanners 11 and 12.

The output of each of the laser beams L1 and L2 may be represented by a waveform other than the rectangular wave. FIG. 13 illustrates a modified example of the output of the laser beam L1 by the laser beam machine 1 illustrated in FIG. 1. The modified example is such that the output of the laser beam L1 is represented by a waveform in which a peak power level is reached at a startup time. The output of the laser beam L2 may be similar to the output of the laser beam L1 and thus may be represented by a waveform similar to the FIG. 13 waveform. Another alternative is that the output of each of the laser beams L1 and L2 may be represented by a waveform close to a Gaussian distribution.

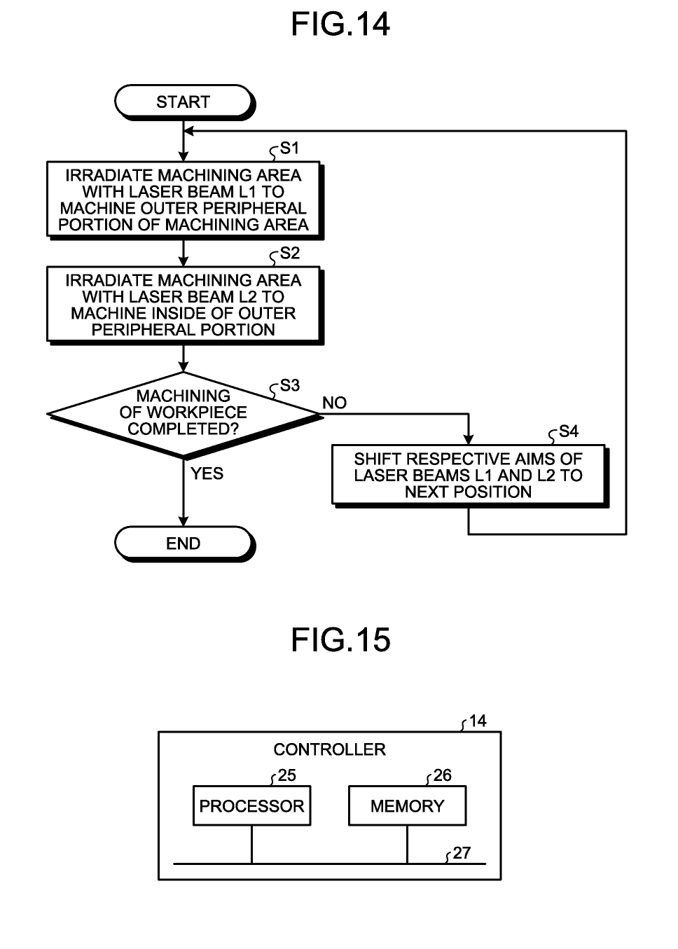

FIG. 14 is a flowchart illustrating steps of the laser beam machining method according to the first embodiment. In step S1, the laser beam machine 1 irradiates the machining area 20 with the laser beam L1 to machine the outer peripheral portion of the machining area 20. In step S2 subsequent to step S1, the laser beam machine 1 irradiates that machining area 20 with the laser beam L2 to machine the portion surrounded by the outer peripheral portion.

After the irradiation of the machining area 20 with the laser beams L1 and L2, the controller 14 determines in step S3 whether or not the machining of the workpiece 15 has been completed. If the machining of the workpiece 15 has not been completed (step S3: No), the laser beam machine 1 shifts the respective aims of the laser beams L1 and L2 to the next position in step S4. The laser beam machine repeats the steps starting from step S1 at the next position. If the machining of the workpiece 15 has been completed (step S3: Yes), the laser beam machine 1 ends the steps illustrated in FIG. 14.

Control functions of the controller 14 are implemented by use of a hardware configuration. FIG. 15 is a block diagram illustrating an example of the hardware configuration of the controller 14 illustrated in FIG. 1. One example of the hardware configuration is a microcontroller. The functions of the controller 14 are each performed in a program that is analyzed and executed by the microcontroller. It is to be noted that some of the functions of the controller 14 may be performed on hardware using wired logic.

The controller 14 includes a processor 25 that executes various processes, and a memory 26 that stores programs for those various processes. The processor 25 and the memory 26 are connected to each other via a bus 27. The processor 25 deploys the loaded programs and executes the various processes for control of the laser beam machine 1.

According to the first embodiment, the laser beam machine 1 irradiates the workpiece 15 alternately with one pulse of the shorter-wavelength laser beam L1 and one pulse of the longer-wavelength laser beam L2. The laser beam machine 1 machines the outer peripheral portion of the machining area 20 by means of irradiation with the laser beam L1 and then machines the portion surrounded by the outer peripheral portion by means of irradiation with the laser beam L2, so that the thermally affected layer 17 that remains in the machined product is made smaller. As such, the laser beam machine 1 is capable of high-quality machining.

### Second Embodiment

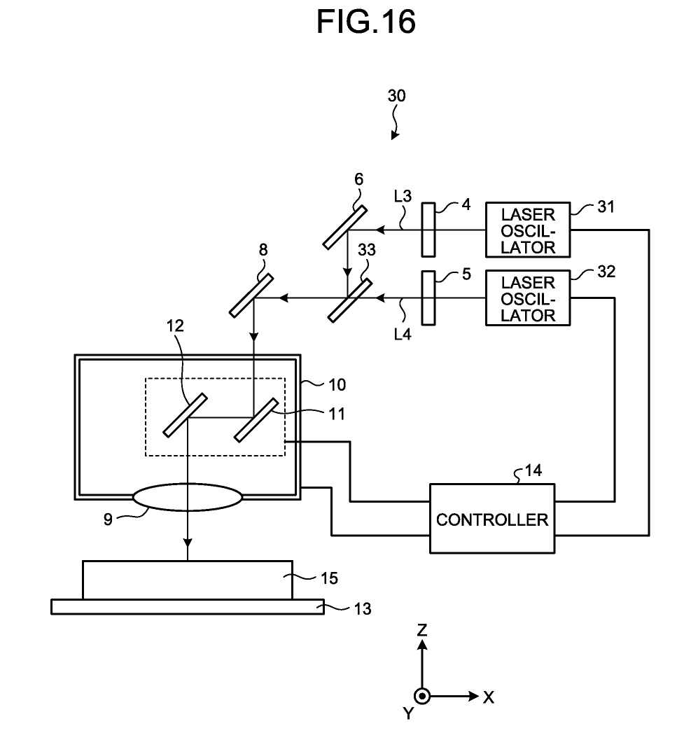

FIG. 16 illustrates a configuration of the laser beam machine 30 according to the second embodiment of the present invention. The laser beam machine 30 machines the workpiece 15 by means of irradiation with laser beams L3 and L4 of different pulse widths in place of the laser beams L1 and L2 of the first embodiment. Parts identical to the parts in the first embodiment have the same reference marks, and redundant descriptions are omitted.

The laser beam machine 30 includes a laser oscillator 31 that is a first laser oscillator and a laser oscillator 32 that is a second laser oscillator. The laser oscillator 31 emits pulses of a first laser beam. The laser oscillator 32 emits pulses of a second laser beam that differs in pulse width from the first laser beam. The laser beam L3 is the first laser beam and is a pulsed laser beam having a first pulse width. The laser beam L4 is the second laser beam and is a pulsed laser beam having a second pulse width. The second pulse width is longer than the first pulse width. In the second embodiment, the laser beam L3 has the same wavelength as the laser beam L4 has.

The beam shaper 4 shapes the laser beam L3 that irradiates the workpiece 15 into a ring-shaped beam profile in which intensity is higher at a periphery than at a beam center. At the workpiece 15, the laser beam L3 thus has the ring-shaped beam profile in which the intensity is higher at the periphery than at the beam center. The beam shaper 5 shapes the laser beam L4 that irradiates the workpiece 15 into a circular beam profile in which intensity is maximal at a beam center. At the workpiece 15, the laser beam L4 thus has the circular beam profile in which the intensity is maximal at the beam center.

Each of the laser oscillators 31 and 32 is a solid-state laser, a semiconductor laser, a fiber laser, a CO₂ laser, or a CO laser. Examples of the respective wavelengths of the laser beams emitted from the laser oscillators 31 and 32 include 10.6 μm, 9.3 μm, 5 μm, 1.06 μm, 1.03 μm, 532 nm, 355 nm, and 266 nm. The laser oscillator 31 emits the laser beam that is short-pulsed and has higher peak power compared with the laser oscillator 32. The first pulse width is shorter than the second pulse width in units of picoseconds, nanoseconds, microseconds, or milliseconds. The pulsed laser beam emitted from the laser oscillator 31 and the pulsed laser beam emitted from the laser oscillator 32 have different polarization directions.

The mirror 6 reflects the laser beam L3 to cause the laser beam L3 to travel toward a thin film polarizer 33. The thin film polarizer 33 is disposed where an optical path of the laser beam L3 coming from the mirror 6 meets an optical path of the laser beam L4 coming from the beam shaper 5. By reflecting the laser beam L3 and transmitting the laser beam L4 having the polarization direction that is different from the polarization direction of the laser beam L3, the thin film polarizer 33 causes the laser beams L3 and L4 to travel in the same direction. It is to be noted that the thin film polarizer 33 may reflect the laser beam L4 and transmit the laser beam L3.

The controller 14 controls the laser oscillators 31 and 32 to cause one pulse of the laser beam L3 and one pulse of the laser beam L4 to alternate in irradiating the workpiece 15. The laser beam machine 30 causes the laser beams L1 and L2 to irradiate the workpiece 15 along a common optical axis. To cut the workpiece 15, the laser beam machine 30 scans the workpiece 15 with the laser beams L3 and L4 while alternating irradiation with the laser beam L3 and irradiation with the laser beam L4. It is to be noted that the laser beam machine 30 may carry out, in addition to cutting, grooving to make grooves or drilling to make holes.

The laser beam machine 30 may include, in place of the laser oscillators 31 and 32 and the beam shapers 4 and 5, one laser oscillator that is capable of emitting laser beams of different pulse widths. Such a laser oscillator emits a laser beam L3 that has a ring-shaped intensity distribution and the first pulse width, and a laser beam L4 that has a circular intensity distribution and the second pulse width. Without using the thin film polarizer 33, such a laser beam machine 30 directs those laser beams L3 and L4 toward a common optical path.

A description is provided here of difference between irradiation with a long-pulsed laser beam and irradiation with a short-pulsed laser beam in the way the workpiece 15 is machined. The long-pulsed laser beam can reach more deeply into the workpiece than the short-pulsed laser beam. If machining is carried out only with the long-pulsed laser beam, the laser beam machine 30 can speed up the machining and thus is capable of high-speed machining. On the other hand, the machining using the long-pulsed laser beam that reaches deep causes a thermally affected layer 17 to have an increased thickness as is the case of irradiation with the longer-wavelength laser beam illustrated in FIG. 6.

As in the case of the irradiation with the shorter-wavelength laser beam as illustrated in FIG. 7, the short-pulsed laser beam can lessen the thermally affected layer 17 that results from energy penetration. If machining is carried out only with the short-pulsed laser beam, the laser beam machine 30 can achieve high-quality machining. On the other hand, the short-pulsed laser beam requires a longer time for machining and can cause a significantly extended period of time from start to end of the machining of the workpiece 15. Laser machining of workpieces is expected to achieve both efficiency and high quality.

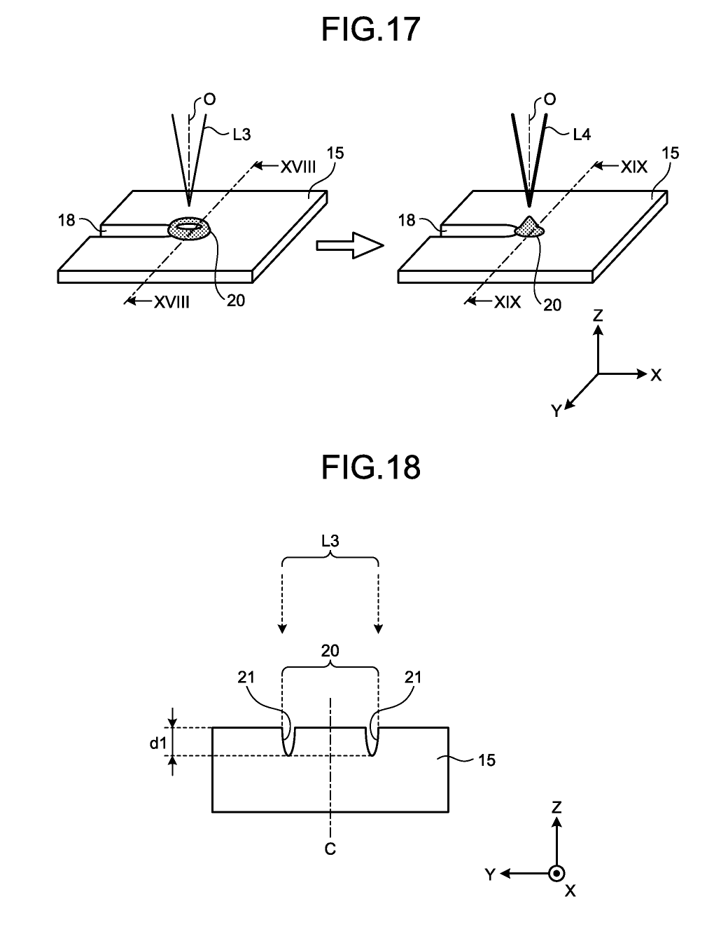

A description is provided next of a machining procedure based on the laser beam machining method according to the second embodiment. FIG. 17 is a first diagram illustrating how the FIG. 16 laser beam machine 30 carries out machining. FIG. 17 illustrates how the workpiece 15 is irradiated with each of the laser beams L3 and L4 while cutting proceeds in a positive X-direction. The laser beam machine 30 causes the respective centers O of the laser beams L3 and L4 to coincide and directs the laser beams L3 and L4 toward a machining area 20 in turn. The laser beam machine 30 can direct the cutting in any direction along each of an X-axis and a Y-axis.

FIG. 18 is a sectional view of the workpiece 15, the section being taken along line XVIII-XVIII of FIG. 17. The laser beam machine 30 machines a ring-shaped outer peripheral portion of the machining area 20 by means of irradiation with the laser beam L3 with the center O of the laser beam L3 coinciding with a center position C of the machining area 20. A machined groove 21 having a depth d1 is thus formed in the outer peripheral portion of the machining area 20. The machined groove 21 is ring-shaped in an X-Y plane.

The intensity at the center O of the laser beam L3 is zero or less than the machining threshold, so that the center position C of the machining area 20 and its proximity are not machined. It is to be noted that the intensity at the center O of the laser beam L3 may be equal to or more than the machining threshold of the workpiece 15 if the intensity of the laser beam L3 that is obtained is sufficient to achieve a machined groove 21 having a certain depth d1 relative to the center position C.

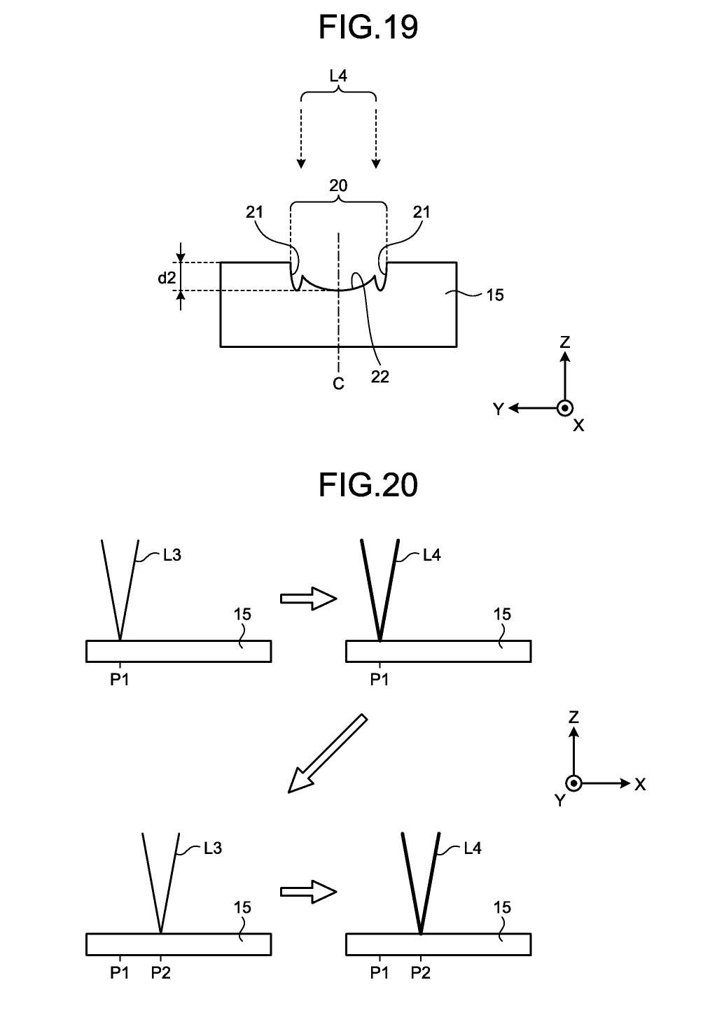

FIG. 19 is a sectional view of the workpiece 15, the section being taken along line XIX-XIX of FIG. 17. After irradiating with the laser beam L3, the laser beam machine 30 irradiates the machining area 20 with the laser beam L4, thus machining a circular portion surrounded by the outer peripheral portion of the machining area 20. Consequently, a machined groove 22 having a depth d2 is formed in the portion surrounded by the outer peripheral portion. The formed machined groove 22 is closer to the center position C than an outer edge of the machined groove 21 formed by the laser beam L3 is.

A portion extending outwardly from the machined groove 21 along the X-axis and the Y-axis of the workpiece 15 remains as a portion of the machined product. By forming the machined groove 21 by means of the irradiation with the short-pulsed laser beam L3, the laser beam machine 30 can lessen the thermally affected layer 17 that remains in the machined product.

By forming the machined groove 21 before the irradiation with the laser beam L4, the laser beam machine 30 keeps the portion that is to be removed by the laser beam L4 apart from the portion that remains in the machined product. A thermally affected layer 17 that results from the irradiation with the long-pulsed laser beam L4 is thus limited to an area that is closer along the X-axis and the Y-axis to the center position C than the outer edge of the machined groove 21 is. In this way, the laser beam machine 30 can suppress X-axis and Y-axis expansion of the thermally affected layer 17 from the machining area 20 and thus can lessen the thermally affected layer 17 that remains in the machined product.

By including the machining using the long-pulsed laser beam L4, the laser beam machine 30 can achieve a reduced time required to machine compared to when carrying out machining using only the short-pulsed laser beam. As such, the laser beam machine 30 can efficiently machine the workpiece 15.

The depth d2 of the machined groove 22 formed by a single irradiation with the laser beam L4 is the same as the depth d1 of the machined groove 21 formed by a single irradiation with the laser beam L3. By using the machined groove 21 to block the expansion of the thermally affected layer 17 that results from the irradiation with the laser beam L4, the laser beam machine 30 can suppress the expansion of the thermally affected layer 17. It is to be noted that the depth d1 of the machined groove 21 formed by the single irradiation with the laser beam L3 is not limited to being the same as the depth d2 of the machined groove 22 formed by the single irradiation with the laser beam L4. The depth d1 of the machined groove 21 may be deeper than the depth d2 of the machined groove 22. Even in that case, the laser beam machine 30 can suppress expansion of the thermally affected layer 17 that results from irradiation with the laser beam L4.

FIG. 20 is a second diagram illustrating how the FIG. 16 laser beam machine 30 carries out the machining. The laser beam machine 30 shifts, through driving of the machining head 10, respective irradiation positions of the laser beams L3 and L4 in the positive X-direction from a machined part.

After aiming the laser beams L3 and L4 at a position P1 illustrated in FIG. 20, the laser beam machine 30 carries out machining using irradiation with the laser beam L3 and thereafter carries out machining using irradiation with the laser beam L4. Upon finishing the machining of the position P1 by means of the laser beams L3 and L4, the laser beam machine 30 shifts respective aims of the laser beams L3 and L4 to a position P2 that is adjacent to the position P1 in the positive X-direction. The laser beam machine 30 carries out machining by irradiating the position P2 with the laser beam L3 followed by the laser beam L4. While shifting the respective aims of the laser beams L3 and L4 in this way, the laser beam machine 30 repeatedly alternates irradiation with one pulse of the laser beam L3 and irradiation with one pulse of the laser beam L4 to machine the workpiece 15.

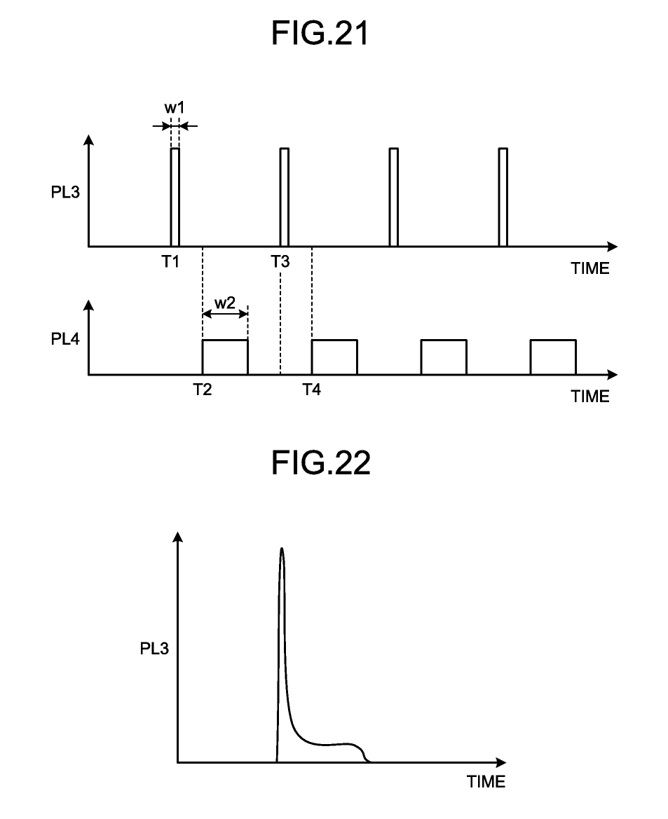

FIG. 21 illustrates outputs of the laser beams L3 and L4 in the FIG. 16 laser beam machine 30. In FIG. 21, a vertical axis PL3 represents power of the laser beam L3, a vertical axis PL4 represents power of the laser beam L4, and horizontal axes each represent time. The laser beam machine 30 repeatedly turns on and off output of the laser beam L3 with the power being constant. The outputs of the laser beam L3 are each represented by a rectangular wave having a constant width w1. The laser beam machine 30 repeatedly turns on and off output of the laser beam L4 with the power being constant. The outputs of the laser beam L4 are each represented by a rectangular wave having a constant width w2. The width w1 is shorter than the width w2, so that a relation, w1<w2, holds.

At the time T1, the laser beam machine 30 emits the laser beam L3 toward the position P1. At the time T2 subsequent to the time T1, the laser beam machine 30 emits the laser beam L4 toward the position P1. By letting the controller 14 control the laser oscillators 31 and 32, the laser beam machine 30 directs the laser beam L3 toward a machining area 20 corresponding to the position P1 and then directs the laser beam L4 toward that machining area 20.

Next, the laser beam machine 30 emits the laser beam L3 toward the position P2 at the time T3 subsequent to the time T2. At the time T4 subsequent to the time T3, the laser beam machine 30 emits the laser beam L4 toward the position P2. By letting the controller 14 control the laser oscillators 31 and 32, the laser beam machine 30 directs the laser beam L3 toward a machining area 20 corresponding to the position P2 and then directs the laser beam L4 toward that machining area 20. With the controller 14 performing the control, the laser beam machine 30 irradiates the workpiece 15 alternately with the one pulse of the laser beam L3 and the one pulse of the laser beam L4. It is to be noted that the laser beam machine 30 may irradiate the workpiece 15 alternately with multiple pulses of the laser beam L3 and multiple pulses of the laser beam L4. The pulse of the laser beam L3 and the pulse of the laser beam L4 may overlap each other.

The laser beam machine 30 not only cuts the workpiece 15 by irradiating each of the positions of the workpiece 15 once with each of the laser beams L3 and L4 but may also cut the workpiece 15 by irradiating each of the positions of the workpiece 15 multiple times alternately with the laser beam L3 and the laser beam L4. In that case, the laser beam machine 30 may scan the workpiece 15 with the laser beams L3 and L4 multiple times through driving of the galvano scanners 11 and 12.

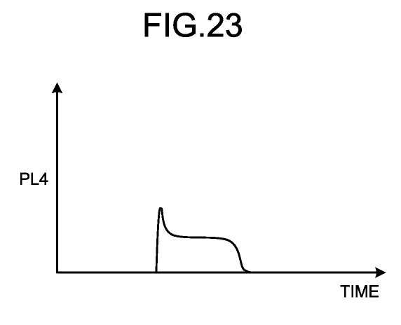

The output of each of the laser beams L3 and L4 may be represented by a waveform other than the rectangular wave. FIG. 22 illustrates a modified example of the output of the laser beam L3 in the FIG. 1 laser beam machine 1. FIG. 23 illustrates a modified example of the output of the laser beam L4 in the FIG. 1 laser beam machine 1. The modified example is such that the output of the laser beam L3 is represented by a waveform in which a peak power level is reached at a startup time. The output of the laser beam L4 is represented by a waveform in which a peak power level is reached at a startup time. Another alternative is that the output of each of the laser beams L3 and L4 may be represented by a waveform close to a Gaussian distribution.

According to the second embodiment, the laser beam machine 30 irradiates the workpiece 15 alternately with one pulse of the short-pulsed laser beam L3 and one pulse of the long-pulsed laser beam L4. The laser beam machine 30 machines the outer peripheral portion of the machining area 20 by means of irradiation with the laser beam L3 and then machines the portion surrounded by the outer peripheral portion by means of irradiation with the laser beam L4, so that the thermally affected layer 17 that remains in the machined product is made smaller. As such, the laser beam machine 30 is capable of high-quality machining.

The above configurations illustrated in the embodiments are illustrative of contents of the present invention, can be combined with other techniques that are publicly known and can be partly omitted or changed without departing from the gist of the present invention.

### REFERENCE SIGNS LIST

1, 30 laser beam machine; 2, 3, 31, 32 laser oscillator; 4, 5 beam shaper; 6, 8 mirror; 7 dichroic mirror; 9 converging optical system; 10 machining head; 11, 12 galvano scanner; 13 stage; 14 controller; 15 workpiece; 16 transmissive area; 17 thermally affected layer; 18 cut surface; 20 machining area; 21, 22 machined groove; 25 processor; 26 memory; 27 bus; 33 thin film polarizer; L1, L2, L3, L4 laser beam.

1-8. (canceled)

9. A laser machining method, which uses a laser beam machine including a first laser oscillator to emit a pulse of a first laser beam, and a second laser oscillator to emit a pulse of a second laser beam differing in one of wavelength and pulse width from the first laser beam, the laser machining method comprising:
machining a first area that is a ring-shaped area of the workpiece using irradiation with the first laser beam having a ring-shaped intensity distribution in which intensity is higher at a periphery than at a beam center, the first area corresponding to an irradiation position of the ring-shaped intensity distribution; and
machining a second area using irradiation with the second laser beam subsequently to the irradiation with the first laser beam, the second area being closer to a ring center than the first area is,
wherein the first laser beam and the second laser beam alternate in irradiating the workpiece.

10. The laser machining method according to claim 9, wherein the second laser beam has a circular beam profile in which intensity is maximal at a beam center.

11. The laser beam machining method according to claim 9, wherein one pulse of the first laser beam and one pulse of the second laser beam are caused to alternate in irradiating the workpiece.

12. The laser beam machining method according to claim 10, wherein one pulse of the first laser beam and one pulse of the second laser beam are caused to alternate in irradiating the workpiece.

13. The laser beam machining method according to claim 9, wherein the first laser beam and the second laser beam are caused to irradiate the workpiece along a common optical axis.

14. The laser beam machining method according to claim 10, wherein the first laser beam and the second laser beam are caused to irradiate the workpiece along a common optical axis.

15. The laser beam machining method according to claim 11, wherein the first laser beam and the second laser beam are caused to irradiate the workpiece along a common optical axis.

16. The laser beam machining method according to claim 12, wherein the first laser beam and the second laser beam are caused to irradiate the workpiece along a common optical axis.

17. A laser beam machine, comprising:
a first laser oscillator to emit a pulse of a first laser beam;
a second laser oscillator to emit a pulse of a second laser beam differing in one of wavelength and pulse width from the first laser beam;
a beam shaper to shape the first laser beam that irradiates a workpiece into a ring-shaped beam profile in which intensity is higher at a periphery than at a beam center; and
controller circuitry configured to cause the first laser beam and the second laser beam to alternate in irradiating the workpiece by controlling the first laser oscillator and the second laser oscillator,
wherein a first area that is a ring-shaped area of the workpiece and corresponds to the ring-shaped beam profile is machined by being irradiated with the first laser beam, and
wherein a second area that is closer to a ring center than the first area is machined by being irradiated with the second laser beam subsequently to the irradiation with the first laser beam.

18. The laser beam machine according to claim 17, wherein the second laser beam that irradiates the workpiece has a circular beam profile in which intensity is maximal at a beam center.

19. The laser beam machine according to claim 17, wherein the controller circuitry causes one pulse of the first laser beam and one pulse of the second laser beam to alternate in irradiating the workpiece.

20. The laser beam machine according to claim 18, wherein the controller circuitry causes one pulse of the first laser beam and one pulse of the second laser beam to alternate in irradiating the workpiece.

21. The laser beam machine according to claim 17, wherein the first laser beam and the second laser beam are caused to irradiate the workpiece along a common optical axis.

22. The laser beam machine according to claim 18, wherein the first laser beam and the second laser beam are caused to irradiate the workpiece along a common optical axis.

23. The laser beam machine according to claim 19, wherein the first laser beam and the second laser beam are caused to irradiate the workpiece along a common optical axis.

24. The laser beam machine according to claim 20, wherein the first laser beam and the second laser beam are caused to irradiate the workpiece along a common optical axis.
